(19) United States
(12) Patent Application Publication
(10) Pub. No.: US 2010/0186004 A1
(43) Pub. Date: Jul. 22, 2010

(54) DATA ANALYSIS SYSTEM AND METHOD

(76) Inventors: SCOTT ALLEN WILL, Wake Forest, NC (US); Kelley Lynne Anders, East New Market, MD (US)

Correspondence Address: IBM CORPORATION, 3039 CORNWALLIS RD., DEPT. T81 / B503, PO BOX 12195, RESEARCH TRIANGLE PARK, NC, 27709, US

(21) Appl. No.: 12/348,097

(22) Filed: Jan. 20, 2009

(51) Int. Cl. G06F 9/44

(52) U.S. Cl. 717/131

(57) ABSTRACT

A method, computer program product, and system for collecting technical support data associated with at least one of a plurality of products, thus generating collected technical support data. The collected technical support data is analyzed to identify one or more product issues within the collected data. One or more product recommendations is generated concerning potential solutions to the one or more identified issues in response to the analysis of the collected technical data.

### TECHNICAL FIELD

The present invention relates to data collection systems and, more particularly to data collection systems for use in a product support environment.

### BACKGROUND

During product support calls, customers often call into a support center to identify a problem. A support engineer may then classify and analyze the problem utilizing e.g., a problem management record (PMR). Unfortunately, the actual analysis of the PMRs has been difficult, often requiring the analyst to utilize special searching tools and methodologies. Specifically, until now, there was no automated way to drill into the data included within the PMRs and derive any benefit without one or more product team members spending hours, and even days, digging into the data.

### SUMMARY OF THE DISCLOSURE

In a first implementation, a method includes collecting technical support data associated with at least one of a plurality of products, thus generating collected technical support data. The collected technical support data is analyzed to identify one or more product issues within the collected data. One or more product recommendations is generated concerning potential solutions to the one or more identified issues in response to the analysis of the collected technical data.

One or more of the following features may be included. Analyzing the collected technical support data to identify one or more product issues within the collected data may include performing a statistical analysis on the collected technical support data. The one or more product recommendations may be provided to a third party. The third party may be a party capable of addressing the one or more product issues. The at least one of a plurality of products may be chosen from the group consisting of: a computer software product; and a computer hardware product.

Collecting technical support data associated with at least one of a plurality of products may include populating one or more data fields within a data input screen. The data input screen may be configured to allow a user to define the collected technical support data. A data record configured to define the collected technical support data may be generated. The data record may be chosen from the group consisting of: a database entry; a spreadsheet entry; an ASCII file entry; and a general data entry. Analyzing the collected technical support data to identify one or more product issues within the collected data may include analyzing the data record to identify the one or more product issues. Generating one or more product recommendations may include generating the one or more product recommendations in a graphical format.

In another implementation, a computer program product resides on a computer readable medium that has a plurality of instructions stored on it. When executed by a processor, the instructions cause the processor to perform operations including collecting technical support data associated with at least one of a plurality of products, thus generating collected technical support data. The collected technical support data is analyzed to identify one or more product issues within the collected data. One or more product recommendations is generated concerning potential solutions to the one or more identified issues in response to the analysis of the collected technical data.

One or more of the following features may be included. Analyzing the collected technical support data to identify one or more product issues within the collected data may include performing a statistical analysis on the collected technical support data. The one or more product recommendations may be provided to a third party. The third party may be a party capable of addressing the one or more product issues. The at least one of a plurality of products may be chosen from the group consisting of: a computer software product; and a computer hardware product.

Collecting technical support data associated with at least one of a plurality of products may include populating one or more data fields within a data input screen. The data input screen may be configured to allow a user to define the collected technical support data. A data record configured to define the collected technical support data may be generated. The data record may be chosen from the group consisting of: a database entry; a spreadsheet entry; an ASCII file entry; and a general data entry. Analyzing the collected technical support data to identify one or more product issues within the collected data may include analyzing the data record to identify the one or more product issues. Generating one or more product recommendations may include generating the one or more product recommendations in a graphical format.

In another implementation, a computing system includes at least one processor and at least one memory architecture coupled with the at least one processor. A first software module is executed on the at least one processor and the at least one memory architecture. The first software module is configured to collect technical support data associated with at least one of a plurality of products, thus generating collected technical support data. A second software module is executed on the at least one processor and the at least one memory architecture. The second software module is configured to analyze the collected technical support data to identify one or more product issues within the collected data. A third software module is executed on the at least one processor and the at least one memory architecture. The third software module is configured to generate one or more product recommendations concerning potential solutions to the one or more identified issues in response to the analysis of the collected technical data.

One or more of the following features may be included. Collecting technical support data associated with at least one of a plurality of products may include populating one or more data fields within a data input screen. The data input screen may be configured to allow a user to define the collected technical support data. A data record configured to define the collected technical support data may be generated. Analyzing the collected technical support data to identify one or more product issues within the collected data may include analyzing the data record to identify the one or more product issues.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a data analysis process coupled to a distributed computing network;

FIG. 2 is a flowchart of the data analysis process of FIG. 1;

FIG. 3 is a diagrammatic view of a data input screen rendered by the data analysis process of FIG. 1;

FIG. 4 is a diagrammatic view of a data input screen rendered by the data analysis process of FIG. 1; and

FIG. 5 is a diagrammatic view of a data input screen rendered by the data analysis process of FIG. 1.

### DETAILED DESCRIPTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++, Visual Basic, a proprietary software language, or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks

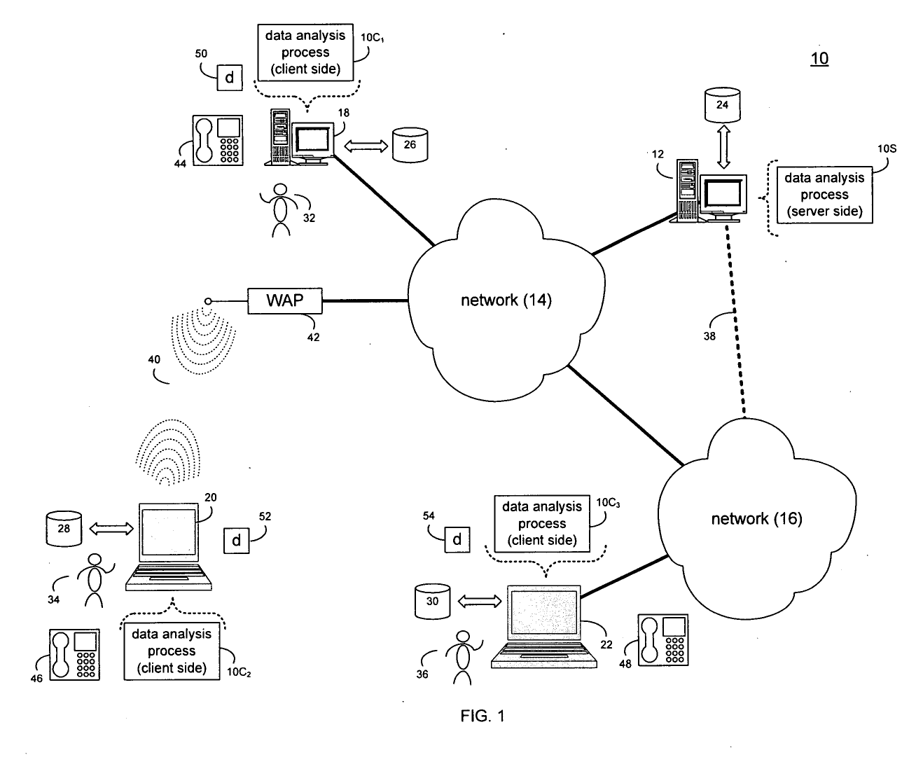

Referring to FIG. 1, there is shown data analysis process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example. Alternatively, data analysis process 10 may reside on a client electronic device, such as a personal computer, notebook computer, personal digital assistant, or the like.

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 16), examples of which may include but are not limited to: a local area network; a wide area network; or an intranet, for example.

As will be discussed below in greater detail, data analysis process 10 may collect technical support data associated with at least one of a plurality of products, thus generating collected technical support data. The collected technical support data may be analyzed to identify one or more product issues within the collected data. One or more product recommendations may be generated concerning potential solutions to the one or more identified issues.

Data analysis process 10 may be a server-side process (e.g., server-side data analysis process 10S) executed on server computer 12; a client side process (client-side data analysis process 10C₁, client-side data analysis process 10C₂, client-side data analysis process 10C₃) executed on a client electronic device (e.g., desktop computer 18, laptop computer 20, notebook computer 22, a personal digital assistant (not shown), a data-enabled, cellular telephone (not shown), and a dedicated network device (not shown), for example); or a hybrid server-side/client-side process that e.g., utilizes server-side data analysis process 10S and at least one of client-side data analysis process 10C₁, client-side data analysis process 10C₂, client-side data analysis process 10C₃ to effectuate the functionality of data analysis process 10.

The instruction sets and subroutines of data analysis process 10S, which may be stored on storage device 24 coupled to server computer 12, may be executed by one or more processors (not shown) and one or more memory architectures (not shown) incorporated into server computer 12. Storage device 24 may include but is not limited to: a hard disk drive; a tape drive; an optical drive; a RAID array; a random access memory (RAM); and a read-only memory (ROM).

The instruction sets and subroutines of data analysis process 10C₁, which may be stored on storage device 26 coupled to desktop computer 18, may be executed by one or more processors (not shown) and one or more memory architectures (not shown) incorporated into desktop computer 18. Storage device 26 may include but is not limited to: hard disk drives; tape drives; optical drives; RAID arrays; random access memories (RAM); read-only memories (ROM), compact flash (CF) storage devices, secure digital (SD) storage devices, and memory stick storage devices.

The instruction sets and subroutines of data analysis process 10C₂, which may be stored on storage device 28 coupled to laptop computer 20, may be executed by one or more processors (not shown) and one or more memory architectures (not shown) incorporated into laptop computer 20. Storage device 28 may include but is not limited to: hard disk drives; tape drives; optical drives; RAID arrays; random access memories (RAM); read-only memories (ROM), compact flash (CF) storage devices, secure digital (SD) storage devices, and memory stick storage devices.

The instruction sets and subroutines of data analysis process 10C₃, which may be stored on storage device 30 coupled to notebook computer 22, may be executed by one or more processors (not shown) and one or more memory architectures (not shown) incorporated into notebook computer 22. Storage device 30 may include but is not limited to: hard disk drives; tape drives; optical drives; RAID arrays; random access memories (RAM); read-only memories (ROM), compact flash (CF) storage devices, secure digital (SD) storage devices, and memory stick storage devices.

Using client-side data analysis process 10C₁, client-side data analysis process 10C₂, client-side data analysis process 10C₃, users 32, 34, 36 (respectively) may access server-side data analysis process 10S and effectuate the functionality of data analysis process 10.

Users (e.g., users 32, 34) may access server computer 12 (i.e., the computer that executes server-side data analysis process 10S) directly through network 14. Additionally/alternatively, server computer 12 may be connected to network 14 through secondary network 16 (as illustrated with link line 38; shown in phantom) and, therefore, users (e.g., user 36) may access server computer 12 via network 16.

The various client electronic devices may be directly or indirectly coupled to network 14 (or network 16). For example, personal computer 18 is shown directly coupled to network 14 via a hardwired network connection. Further, notebook computer 22 is shown directly coupled to network 16 via a hardwired network connection. Laptop computer 20 is shown wirelessly coupled to network 14 via wireless communication channel 40 established between laptop computer 20 and wireless access point (i.e., WAP) 42, which is shown directly coupled to network 14. WAP 42 may be, for example, an IEEE 802.11a, 802.11b, 802.11g, Wi-Fi, and/or Bluetooth device that is capable of establishing wireless communication channel 40 between laptop computer 18 and WAP 42.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 18, 20, 22 may each execute an operating system, examples of which may include but are not limited to Microsoft Windows™, Microsoft Windows CE™, Redhat Linux™, or a custom operating system.

Data Analysis Process

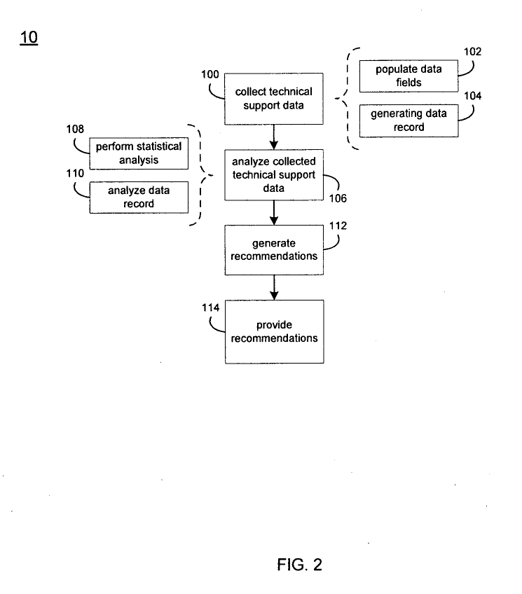

Referring also to FIG. 2, data analysis process 10 may be utilized as part of a technical support system (not shown) that provides technical support for e.g., computer hardware and/or software and may collect technical support data concerning e.g., hardware and software products and may analyze the collected technical support data to identify one or more product issues within the collected data.

For example, assume for illustrative purposes that users 32, 34, 36 are technical support personnel at a technology company. Assume that while performing their job, users 32, 34, 36 may receive technical support phone calls (via telephones 44, 46, 48) from customers of products offered by the software company.

While the following example is based upon a technology company, this is for illustrative purposes only and is not intended to be a limitation of this disclosure, as other configurations are possible. For example, another illustrative example of such a company may include a machinery company that produces machine tools and the technical support calls received from users of the machine tools produced by the machinery company.

Additionally, while the following example is based upon telephone-based communications between e.g., users 32, 34, 36 and customers, this is for illustrative purposes only, as other configurations are possible and are consider to be within the scope of this disclosure. For example, communications may be established between e.g., users 32, 34, 36 and various customers using e.g., an instant messaging system and/or an email system.

While performing their job, data analysis process 10 may allow users 32, 34, 36 to collect 100 technical support data associated with one or more of the products offered by the technology company, resulting in the generation of collected technical support data 50, 52, 54 (respectively). Examples of such products may include but are not limited to computer software products (e.g., operating systems, server applications, networking applications, security applications, and productivity applications) and computer hardware products (e.g., desktop computers, laptop computers, server computers, networking devices, and handheld devices).

Further, assume that user 32, 34, 36 discuss (with the customer) the specific technical support issue that the customer would like to have resolved. For example, a first customer may be contacting user 32 because the server computer that they purchased will not boot up; a second customer may be contacting user 34 because an email application that they purchased and are trying to install keeps locking up during the “select default language” portion of the installation process; and a third customer may be contacting user 36 because their server computer cannot see a recently-installed SCSI storage device.

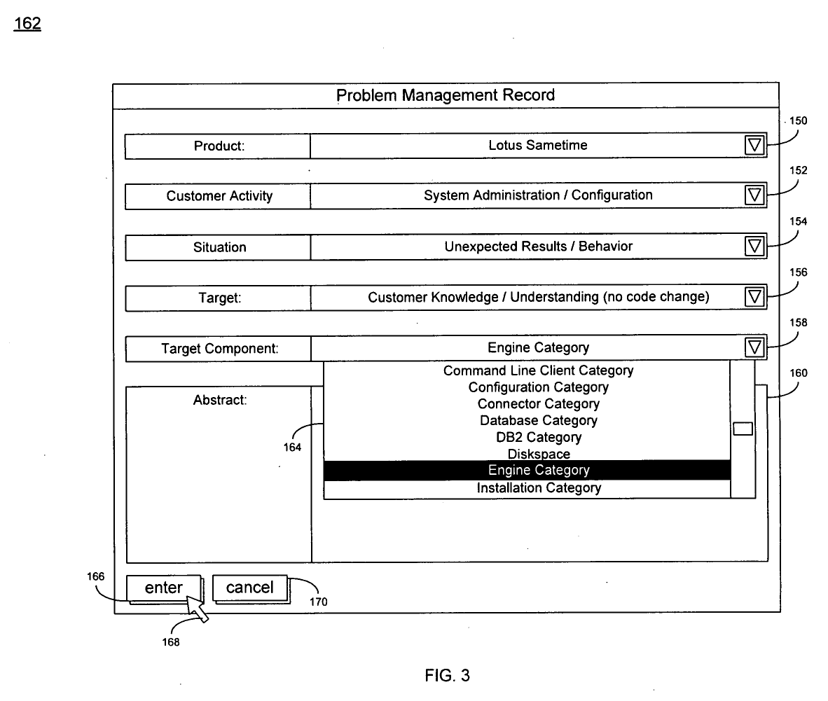

Referring also to FIG. 3, user 32, 34, 36 may troubleshoot each of these problems with their respective customers (the first customer, the second customer, and the third customer; respectively) and may logically and systematically obtain the desired result (i.e., the resolution of the issue that prompted the customer to call). When collecting 100 the above-described technical support data, one or more of users 32, 34, 36 may populate 102 one or more data fields (e.g., “Product” field 150, “Customer Activity” field 152, “Situation” field 154, “Target” field 156, “Target Component” field 158, and “Abstract” field 160) within a data input screen (e.g., data input screen 162). Data field 150, 152, 154, 156, 158, 160 are merely illustrative examples of the types of data fields that a user (e.g., user 32, 34, 36) may populate 102 within data input screen 162 and are not intended to be a limitation of this disclosure, as the data may vary depending upon the needs of the user.

Data input screen 162 may be configured to allow the user (e.g., user 32, 34, 36) to define the collected technical support data. For example, data input screen 122 may utilize drop down menus (e.g., drop down menu 164 that, in this example, is associated with “Target Component” data field 158). Specifically, by allowing the user to select from a plurality of predefined answers that are used to populate 102 the various data fields (e.g., data fields 150, 152, 154, 156, 158, 160) included within data input screen 162, the technical support data collected may be subsequently processed and the generated results may be utilized to enhance the performance of the products produced by (in the example) the technology company.

Continuing with the above-stated example, assume that a Lotus Sametime™ customer calls technical support and is connected to user 32. During the initial portion of the telephone-based technical support call, user 32 may ask the following questions “Which product are you calling about?”, to which the customer may identify “Lotus Sametime”. User 32 may utilize the dropdown menu (not shown) associated with “Product” data field 150 to define “Lotus Sametime”.

Once “Product” data field 150 is populated 102, user 32 may ask the customer e.g., what they were doing at the time that the problem occurred. User 32 may utilize the dropdown menu (not shown) associated with “Customer Activity” data field 152 to define “System Administration/Configuration” in response to the customer explaining that they were in the process of initially configuring Lotus Sametime™. The specific selections defined within the dropdown menu (not shown) associated with “Customer Activity” data field 152 may vary depending upon the selection made within “Product” data field 150. In order to properly frame the customer's response to the inquiries of user 32, user 32 may identify and explain the various options defined within the dropdown menu (not shown) associated with “Customer Activity” data field 152.

Once “Customer Activity” data field 152 is populated 102, user 32 may ask the customer e.g., to identify the problem encountered. User 32 may utilize the dropdown menu (not shown) associated with “Situation” data field 154 to define “Unexpected Result/Behavior” in response to the customer explaining that they were presented with a question during installation that asked the customer to identify the primary domain controller within their network. As the customer did not know how to answer this question, the user decided to call technical support. Again, the specific selections defined within the dropdown menu (not shown) associated with “Situation” data field 154 may vary depending upon the selection made within “Customer Activity” data field 152. Additionally, in order to properly frame the customer's response to the inquiries of user 32, user 32 may identify and explain the various options defined within the dropdown menu (not shown) associated with “Situation” data field 154.

The above-described population of data fields may be repeated until all drop-down menu based data fields (e.g., data fields 150, 152, 154, 156, 158) identified within data input screen 162 are populated 102. During the course of the above-described telephone discussion, the problem described by the customer may be resolved by user 32. In addition to drop-down menu based fields (e.g., data fields 150, 152, 154, 156, 158), one or more free form fields (e.g., “Abstract” data field 160) may be included within data input screen 162 that e.g., may allow user 32 to enter freeform notes that provide additional information concerning e.g., the resolution of the problem.

Once the problem is resolved and/or data input screen 162 is populated 102 with the requisite quantity of information, user 32 may select “enter” button 166 using onscreen pointer 168, which may be controllable via a pointing device (e.g., a mouse; not shown). Alternatively, user 32 may select “cancel” button 170 to delete the technical support data populating 102 data input screen 162.

Upon user 32 selecting “enter” button 166, a data record (e.g., a PMR) defining the collected technical support data may be generated 104. Examples of such a data record may include but are not limited to: an entry within a database; an entry within a spreadsheet; an entry within an ASCII file; and an entry within a general data file.

Once the above-described technical support data (e.g., as defined within data input screen 162) is collected 100, data analysis process 10 may analyze 106 the technical support data to identify one or more product issues within the collected data. For example and as will be discussed below in greater detail, when analyzing 106 the collected technical support data, data analysis process 10 may e.g., perform 108 a statistical analysis of the collected technical support data and/or analyze 110 data record(s) generated 104 to identify the one or more product issues.

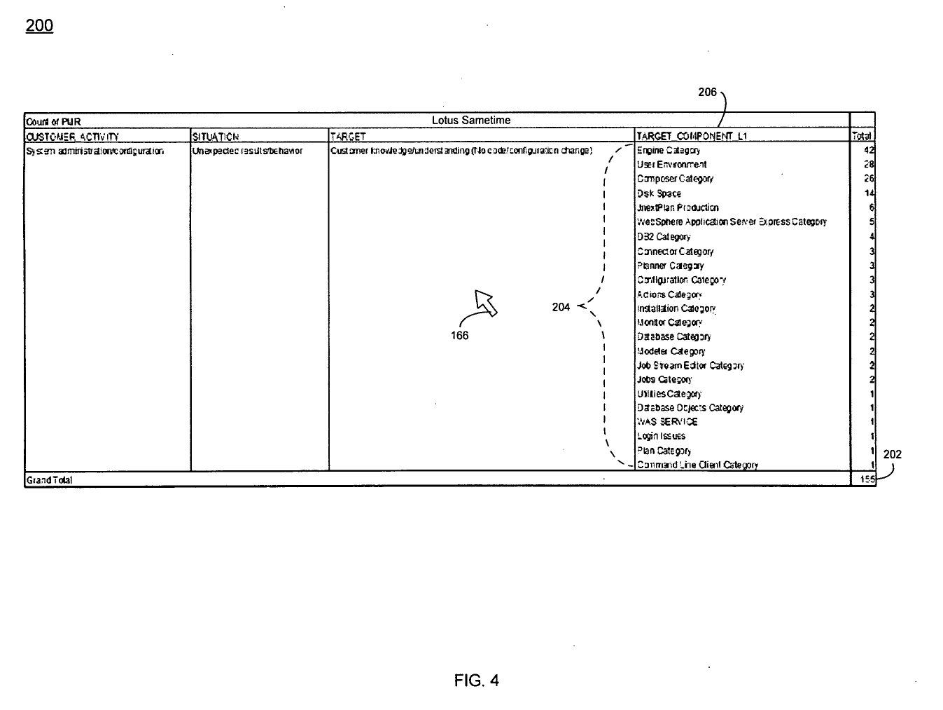

For example and referring also to FIG. 4, when data analysis process 10 analyzes 106 the technical support data collected 100, the technical support data may be presented to a user (e.g., a technical support analyst) as table 200 (e.g., a pivot table). In this illustrative example, table 200 is a multi column table that summarizes a portion of the technical support data obtained for a particular product (e.g., Lotus Sametime™) from a group of customers. Specifically, table 200 shows the distribution of response options within “Target Component” data field 158 when the “Customer Knowledge/Understanding (no code change)” response option is selected within “Target” data field 156.

As shown in table 200, the “Customer Knowledge/Understanding (no code change)” response option was selected within “Target” data field 156 of data input screen 162 a total of one-hundred-fifty-five times (as shown within cell 202). Of these one-hundred-fifty-five responses, the “Engine Category” response option was selected forty-two times, the “User Environment” response option was selected twenty-eight times, the “Composer Category” response option was selected twenty-six times, and so on.

While the technical support data included within table 200 is illustrated in a tabular format, this is for illustrative purposes only and is not intended to be a limitation of this disclosure. Specifically, the technical support data may be illustrated in a graphical format that is presented to a user, examples of which may include but are not limited to a pie chart, a line chart, and a bar chart.

As discussed above, data analysis process 10 may analyze 106 the technical support data obtained from the customers to identify one or more product issues within the collected data. For example, table 200 illustrates that there are twenty-three possible “Target Component” response options 204 (as defined within column 206 of table 200). Additionally, the first four possible response options (i.e., approximately 12% of the thirty-three available response options), namely the “Engine Component” response option, the “User Environment” response option, the “Composer Category” response option, and the “Disk Space” response option) account for one-hundred-ten of the one-hundred-fifty-five responses received (i.e., approximately 71%).

Accordingly, it appears that these four response options account for a disproportionately high percentage of the total responses received. Accordingly, data analysis process 10 may analyze 106 this technical support data to generate 112 one or more product recommendations concerning potential solutions for this identified issue. In this specific example, the particular category that these one-hundred-fifty-five responses fall under is “Customer Knowledge/Understanding Category (No Code/Configuration Change)”. Accordingly, these first four response options (which account for 71% of the total responses received) may be addressed via e.g., enhancements to the physical documentation included with the provided product, enhancements to the software-based documentation included with the provided product, enhancements to the online help available concerning the provided product, enhancements to an online knowledgebase concerning the provided product, and changes to the product to make the product more “intuitive” to the user (which may be referred to as “usability” improvements).

Accordingly, the product recommendation generated 112 by data analysis process 10 may recommend enhancements to the documentation concerning the portions of the product that are related to the “Engine Component” response option, the “User Environment” response option, the “Composer Category” response option, and the “Disk Space” response option. Additionally, data analysis process 10 may recommend that the consumability/usability of the related areas of the product be improved so that any unexpected occurrence is either eliminated or clearly shown to be an “expected” occurrence. Further still, data analysis process 10 may recommend that the serviceability of the product be improved (e.g., via diagnostic tools) so that any failures are transparent to the customer.

While the recommendations generated 112 by data analysis process 10 are described above as being tabular/text-based, this is for illustrative purposes only and is not intended to be a limitation of this disclosure. Specifically, the recommendations generated 112 by data analysis process 10 may be illustrated in a graphical format, examples of which may include but are not limited to a pie chart, a line chart, and a bar chart.

The product recommendations generated 112 by data analysis process 10 may be provided 114 to a third party, examples of which may include but are not limited to a product manager, a quality control manager, an engineer, a programmer, or any other party capable of addressing the product issues identified with the product recommendation. Upon the third party receiving the above-described product recommendations, the third party may consider the product recommendations and (if appropriate) effectuate the same.

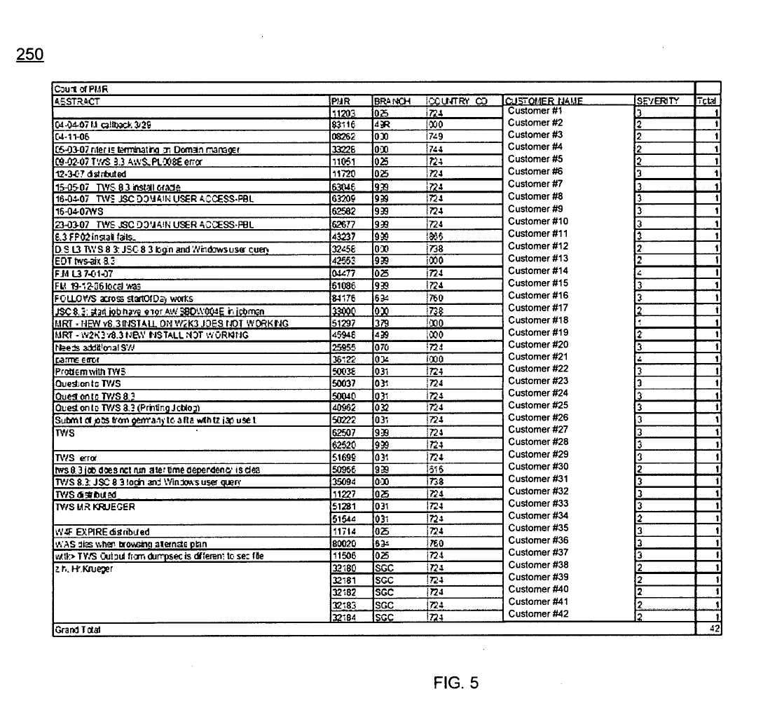

Data analysis process 10 may be configured to allow a user to select a portion of table 200 so that additional data may be obtained concerning the portion selected. For example, user 32 may select (via onscreen pointer 168) the number “42” that defines the number of times that the “Engine Category” response option was selected, which may result in the generation of table 250 (See FIG. 5) that defines e.g., the notes (as defined within “Abstract” field 160 of data input screen 162) of the corresponding data record. Data analysis process 10 may be configured to perform rudimentary textual analysis 106 of all the words that appear within the notes of the related forty-two data records. Additionally/alternatively, artificial intelligence (e.g., such as that included within LanguageWare™) may be utilized to process some or all of the notes of e.g., the corresponding forty-two data records.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method comprising:
collecting technical support data associated with at least one of a plurality of products, thus generating collected technical support data;
analyzing the collected technical support data to identify one or more product issues within the collected data; and
generating one or more product recommendations concerning potential solutions to the one or more identified issues in response to the analysis of the collected technical data.

2. The method of claim 1 wherein analyzing the collected technical support data to identify one or more product issues within the collected data includes:
performing a statistical analysis on the collected technical support data.

3. The method of claim 1 further comprising:
providing the one or more product recommendations to a third party.

4. The method of claim 1 wherein the third party is a party capable of addressing the one or more product issues.

5. The method of claim 1 wherein the at least one of a plurality of products is chosen from the group consisting of: a computer software product; and a computer hardware product.

6. The method of claim 1 wherein collecting technical support data associated with at least one of a plurality of products includes:
populating one or more data fields within a data input screen, wherein the data input screen is configured to allow a user to define the collected technical support data; and
generating a data record configured to define the collected technical support data.

7. The method of claim 6 wherein the data record is chosen from the group consisting of: a database entry; a spreadsheet entry; an ASCII file entry; and a general data entry.

8. The method of claim 6 wherein analyzing the collected technical support data to identify one or more product issues within the collected data includes:
analyzing the data record to identify the one or more product issues.

9. The method of claim 6 wherein generating one or more product recommendations includes:
generating the one or more product recommendations in a graphical format.

10. A computer program product residing on a computer readable medium having a plurality of instructions stored thereon, which, when executed by a processor, cause the processor to perform operations comprising:
collecting technical support data associated with at least one of a plurality of products, thus generating collected technical support data;
analyzing the collected technical support data to identify one or more product issues within the collected data; and
generating one or more product recommendations concerning potential solutions to the one or more identified issues in response to the analysis of the collected technical data.

11. The computer program product of claim 10 wherein the instructions for analyzing the collected technical support data to identify one or more product issues within the collected data include instructions for:
performing a statistical analysis on the collected technical support data.

12. The computer program product of claim 10 further comprising instructions for:
providing the one or more product recommendations to a third party.

13. The computer program product of claim 10 wherein the third party is a party capable of addressing the one or more product issues.

14. The computer program product of claim 10 wherein the at least one of a plurality of products is chosen from the group consisting of: a computer software product; and a computer hardware product.

15. The computer program product of claim 10 wherein the instructions for collecting technical support data associated with at least one of a plurality of products include instructions for:
populating one or more data fields within a data input screen, wherein the data input screen is configured to allow a user to define the collected technical support data; and
generating a data record configured to define the collected technical support data.

16. The computer program product of claim 15 wherein the data record is chosen from the group consisting of: a database entry; a spreadsheet entry; an ASCII file entry; and a general data entry.

17. The computer program product of claim 15 wherein the instructions for analyzing the collected technical support data to identify one or more product issues within the collected data include instructions for:
analyzing the data record to identify the one or more product issues.

18. The computer program product of claim 15 wherein the instructions for generating one or more product recommendations include instructions for:
generating the one or more product recommendations in a graphical format.

19. A computing system comprising:
at least one processor;
at least one memory architecture coupled with the at least one processor;
a first software module executed on the at least one processor and the at least one memory architecture, wherein the first software module is configured to collect technical support data associated with at least one of a plurality of products, thus generating collected technical support data;
a second software module executed on the at least one processor and the at least one memory architecture, wherein the second software module is configured to analyze the collected technical support data to identify one or more product issues within the collected data; and
a third software module executed on the at least one processor and the at least one memory architecture, wherein the third software module is configured to generate one or more product recommendations concerning potential solutions to the one or more identified issues in response to the analysis of the collected technical data.

20. The computing system of claim 19 wherein the first software module is further configured to:
populate one or more data fields within a data input screen, wherein the data input screen is configured to allow a user to define the collected technical support data; and
generate a data record configured to define the collected technical support data.

21. The computing system of claim 20 wherein the second software module is further configured to:
analyze the data record to identify the one or more product issues.
